(19) United States
(12) Patent Application Publication
(10) Pub. No.: US 2026/0084941 A1
(43) Pub. Date: Mar. 26, 2026

(54) DESCENDING STROKE ADJUSTABLE DEVICE FOR A LIFTING TOOL

(71) Applicant: ALTACHEM, Harelbeke (BE)

(72) Inventors: Yanming ZHANG, Jinhua (CN); Suhua ZHANG, Jinhua (CN); Weidong SHEN, Jinhua (CN)

(21) Appl. No.: 19/111,026

(22) PCT Filed: Sep. 13, 2023
(86) PCT No.: PCT/EP2023/075158

§ 371 Date: Mar. 12, 2025

(30) Foreign Application Priority Data
Sep. 13, 2022 (CN) 202222421312.2

(51) Int. Cl. B66F 1/02

(52) U.S. Cl. CPC B66F 1/02

(57) ABSTRACT

The disclosure relates to a descending stroke adjustable device for a lifting tool. The lifting tool includes a frame and a support rod. The support rod is axially arranged in a penetrating manner in the frame. A descending stroke adjustable device is mounted out of an upper end of the frame and includes a height descending device and a stroke adjusting device. The height descending device is penetrated by the support rod, and a descending stopping spring is compressively mounted between the height descending device and an upper end surface of the frame so that the height descending device and the support rod keep a descending stopping inclination angle; and the stroke adjusting device achieves an adjustable step-down stroke by accurately controlling an up-down moving range when the height descending device is pressed.

### TECHNICAL FIELD

The present invention belongs to the technical field of home decoration tools, and in particular to a descending stroke adjustable device for a lifting tool.

### BACKGROUND

In recent years, lifting tools (also known as jacking tools, lifters, and the like) derived from caulking guns have emerged in the field of home decoration tools, which may be applied to application scenarios such as wall tile paving and furniture lifting and may make specific operations such as lifting and leveling more labor-saving and convenient. However, the lifting tools with only speed decreasing function cannot satisfy increasingly diversified application scenarios: for example, if the object is over-lifted, the height needs to decrease slightly. To achieve a purpose of slowly decreasing the height, technicians also put forward a novel technical solution. For example, a patent published by the China National Intellectual Property Administration and named “Lowering Mechanism for Handheld Jacking Tool” with publication No. CN113811660A discloses a lowering mechanism to achieve the purpose of lowering the height step by step. However, each descending height of the descending mechanism is controlled according to a pressing amplitude of the lowering mechanism, and its descending height is still unstable, so that such a lowering mechanism still cannot satisfy usage scenarios where the descending height needs to be accurately controlled.

### SUMMARY

To solve the above problems in the prior art, the present invention provides a descending stroke adjustable device for a lifting tool, which can satisfy the requirements of usage scenarios where the descending height is accurately controlled.

The present invention adopts the following technical solution:
A descending stroke adjustable device for a lifting tool, the lifting tool including a frame, a trigger, a support rod, a descending stopping spring, a lifting piece, and a lifting reset spring, the support rod is axially arranged in a penetrating manner in the frame; a lower end of the support rod is located out of the frame and a support leg is arranged at the lower end of the support rod; a lifting leg is arranged at a lower end of the frame; and a separation distance between the lifting leg and the support leg is adjusted by moving the support rod; the support rod, being located inside the frame, is equipped with a lifting piece which is capable of driving said support rod to move downwards; the lifting reset spring is arranged between the lifting piece and the frame; the lifting piece is connected to a trigger driving the lifting piece to incline downwards; and the trigger is hinged to the frame and forms an included angle with a grip on one side of an upper part of the frame; where a descending stroke adjustable device is mounted out of an upper end of the frame, the descending stroke adjustable device includes a height descending device and a stroke adjusting device, the height descending device is penetrated by the support rod, and a descending stopping spring is compressively mounted between the height descending device and an upper end surface of the frame, so that the height descending device and the support rod keep a descending stopping inclination angle; and the stroke adjusting device achieves an adjustable step-down stroke by accurately controlling an up-down moving range when the height descending device is pressed.

Further, the height descending device includes a speed decreasing plate and a step-down device; the step-down device includes a step-down plate and a pressing plate in pin connection; the speed decreasing plate and the step-down plate are arranged up and down; the speed decreasing plate and the step-down plate both are correspondingly provided with through holes for the support rod to penetrate through; ends, away from the pressing plate, of the speed decreasing plate and the step-down plate are connected through an elastic retainer; and an end, close to the pressing plate, of the speed decreasing plate is hinged with one end of the pressing plate through a connecting plate.

Further, the step-down plate is further provided with a joining part below a hinged position of the connecting plate and the pressing plate, and when a hinged part off the speed decreasing plate is pressed down, the connecting plate is linked and the joining part is pressed to drive the step-down plate to be kept perpendicular to the support rod synchronously.

Further, the elastic retainer is a tension spring.

Further, a small pressure spring for resetting is arranged between a lower side of the pressing plate and the upper end surface of the frame.

Further, an upward extension part of the frame on the opposite side of the grip is provided with a first accommodation hole and a second accommodation hole, and the ends, away from the pressing plate, of the speed decreasing plate and the step-down plate are respectively inserted into the first accommodation hole and the second accommodation hole.

Further, the stroke adjusting device is a screw which is axially movably screwed to the upper end of the first accommodation hole of the frame in an axial direction, and an up-down moving range of the speed decreasing plate is accurately controlled through an axial displacement change of the screw to adjust a descending stroke.

Further, a self-positioning device is arranged in a middle of the screw to keep a stable position of the screw.

Further, a rotating part is arranged at an upper end of the screw, so that the rotating part is adjusted in a more convenient and labor-saving manner.

Or, the stroke adjusting device is an eccentric locking shaft rotatably mounted on a side wall of the first accommodation hole of the frame along a radial direction, and the up-down moving range of the speed decreasing plate is accurately controlled through a change of an eccentric amount of the eccentric locking shaft to adjust the descending stroke.

The present invention has the following beneficial effect: the descending stroke is adjusted by arranging the stroke adjusting device, so that the requirements of usage scenarios where the descending height is accurately controlled can be satisfied.

### BRIEF DESCRIPTION OF THE DRAWINGS

FIG. 1 is a schematic diagram of an embodiment I of the present invention applied to a lifting tool;

FIG. 2 is a partially sectional view of a first adjusting position of an embodiment I of the present invention;

FIG. 3 is a partially sectional view of a second adjusting position of the embodiment I of the present invention;

FIG. 4 is a schematic diagram of a height descending device in the embodiment I of the present invention;

FIG. 5 is a schematic diagram of a step-down plate in the embodiment I of the present invention;

FIG. 6 is a partially sectional view of a first adjusting position of an embodiment II of the present invention; and

FIG. 7 is a partially sectional view of a second adjusting position of the embodiment II of the present invention.

In the drawings: 1, frame; 1a, first accommodation hole; 1b, second accommodation hole; 2, lifting leg; 3, support leg; 4, trigger; 5, support rod; 6, descending stopping spring; 7, lifting piece; 8, lifting reset spring; 9, descending stroke adjustable device; 91/91′, stroke adjusting device; 91a, self-positioning device; 92, speed decreasing plate; 92a, first through hole; 92b, first hanging hole; 92c, first pin hole; 93, connecting plate; 94, pressing plate; 95, small pressure spring; 96, step-down plate; 96a, second through hole; 96b, second hanging hole; 96c, second pin hole; 96d, joining part; and 97, elastic retainer.

### DETAILED DESCRIPTION

The present invention will be further described in detail below in conjunction with specific embodiments, but the protection scope of the present invention is not limited to these specific embodiments. Those skilled in the art should recognize that the present invention covers all alternative schemes, improved schemes and equivalent schemes probably included in the scope of the claims.

In the description of the present invention, it should be understood that orientation or position relationships indicated by the terms such as “center”, “longitudinal”, “transverse”, “length”, “width”, “thickness”, “upper”, “lower”, “front”, “rear”, “left”, “right”, “vertical”, “horizontal” , “top”, “bottom”, “inside”, “clockwise”, “anticlockwise”, and the like are based on orientation or position relationships shown in the accompanying drawings, and are used only for ease and brevity of illustration and description, rather than indicating or implying that the mentioned apparatus or component needs to have a particular orientation or needs to be constructed and operated in a particular orientation. Therefore, such terms should not be construed as limiting of the present invention. In addition, terms “first” and “second” are used merely for the purpose of description, and shall not be construed as indicating or implying relative importance or implying a quantity of indicated technical features. Therefore, a feature limited by “first” or “second” may explicitly or implicitly include one or more of the features. In descriptions of the present invention, “a plurality of” means two or more, unless otherwise defined clearly and specifically.

In the present invention, unless otherwise explicitly specified and limited, the terms “mount”, “connect”, “connection”, “fix”, and the like should be understood in a broad sense. For example, a connection may be a fixed connection, a detachable connection, or an integral connection; or the connection may be a mechanical connection or an electrical connection; or the connection may be a direct connection, an indirect connection through an intermediary, or internal communication between two components. A person of ordinary skill in the art can understand specific meanings of the terms in the present invention according to specific situations.

In the present invention, unless otherwise explicitly specified and limited, a first feature is “on” or “under” a second feature, which may include that the first and second features are in direct contact, or may include that the first and second features are not in direct contact but in contact by using other features therebetween. In addition, the first feature is “on”, “above”, and “over” the second feature, which includes that the first feature is right above and on the inclined top of the second feature or merely indicates that a level of the first feature is higher than that of the second feature. The first feature is “below”, “under”, and “beneath” the second feature, which includes that the first feature is right below and obliquely below the second feature or merely indicates that a level of the first feature is lower than that of the second feature.

### Embodiment I

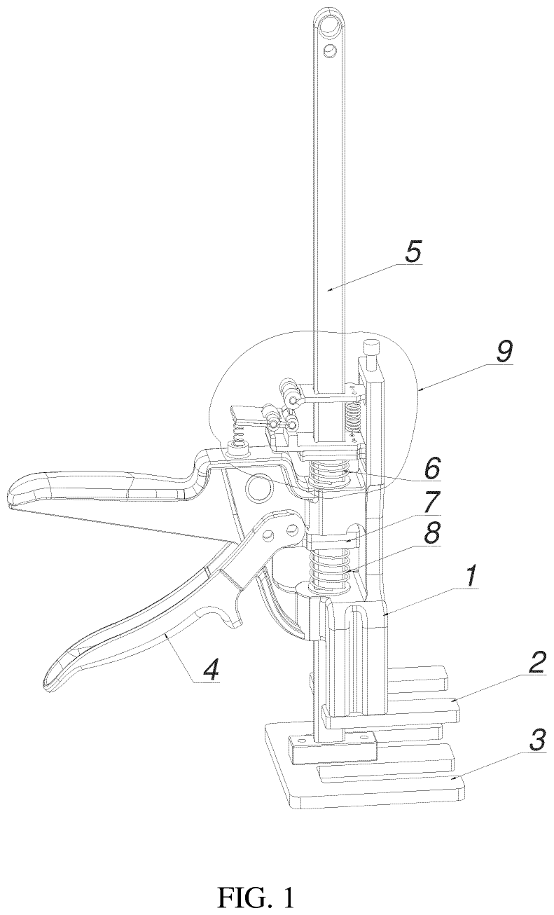

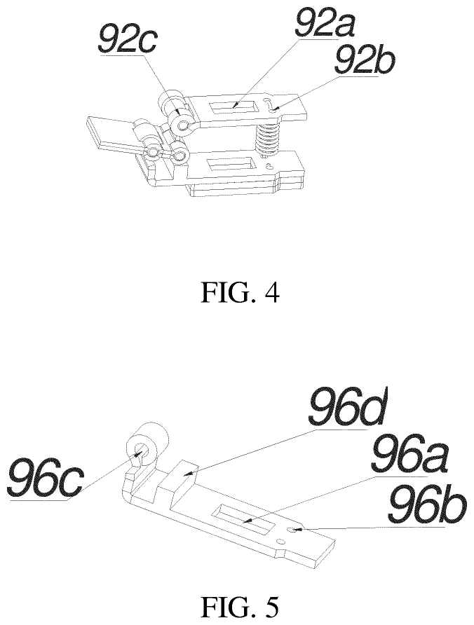

Referring to FIG. 1 to FIG. 5, the embodiment provides a descending stroke adjustable device for a lifting tool, the lifting tool including a frame 1, a trigger 4, a support rod 5, a descending stopping spring 6, a lifting piece 7, and a lifting reset spring 8; the support rod 5 is axially arranged in a penetrating manner in the frame 1; a lower end of the support rod 5 is located out of the frame 1 and a support leg 3 is arranged at the lower end of the support rod; a lifting leg 2 is arranged at a lower end of the frame 1; and a separation distance between the lifting leg 2 and the support leg 3 is adjusted by moving the support rod 5; the support rod 5, being located inside the frame 1, is equipped with a lifting piece 7 which is capable of driving said support rod 5 to move downwards; the lifting reset spring 8 is arranged between the lifting piece 7 and the frame 1; the lifting piece 7 is connected to the trigger 4 driving the lifting piece to incline downwards; and the trigger 4 is hinged to the frame 1 and forms an included angle with a grip on one side of an upper part of the frame 1; the trigger 4 is pulled to make the lifting piece 7 to incline downwards, so as to drive the support rod 5 to move downwards or drive the frame 1 to move upwards; and when the support rod 5 moves downwards or the frame 1 moves upwards, the separation distance between the support leg 3 and the lifting leg 2 is also opened synchronously.

In the embodiment, a descending stroke adjustable device 9 is mounted out of an upper end of the frame 1, the descending stroke adjustable device 9 includes a height descending device and a stroke adjusting device 91, the height descending device is penetrated by the support rod 5, and the descending stopping spring 6 is compressively mounted between the height descending device and an upper end surface of the frame 1, so that the height descending device and the support rod 5 keep a descending stopping inclination angle; and the stroke adjusting device 91 achieves an adjustable step-down stroke by accurately controlling an up-down moving range when the height descending device is pressed. The height descending device includes a speed decreasing plate 92 and a step-down device; the step-down device includes a step-down plate 96 and a pressing plate 94 in pin connection; the speed decreasing plate 92 and the step-down plate 96 are arranged up and down; ends, away from the pressing plate 94, of the speed decreasing plate 92 and the step-down plate 96 are connected through an elastic retainer 97; and the elastic retainer 97 is a tension spring; and an end, close to the pressing plate 94, of the speed decreasing plate 92 is hinged with one end of the pressing plate 94 through a connecting plate 93. Specifically, the speed decreasing plate 92 is provided with a first hanging hole 92b, a first through hole 92a, and a first pin hole 92c; the step-down plate 96 is provided with a second hanging hole 96b, a second through hole 96a, and a second pin hole 96c; and the first hanging hole 92b and the second hanging hole 96b are formed correspondingly for hooking both ends of the tension spring; the first through hole 92a and the second through hole 96a are formed corresponding for the support rod 5 to penetrate through; and the first pin hole 92c is used for hinging with the connecting plate 93, and the second pin hole 96c is used for hinging with the pressing plate 94. The step-down plate 96 is further provided with a joining part 96d below a hinged position of the connecting plate 93 and the pressing plate 94, and when a hinged part of the speed decreasing plate 92 is pressed down, the connecting plate 93 is linked and the joining part 96d is pressed to drive the step-down plate 96 to be kept perpendicular to the support rod 5 synchronously to achieve speed decrease. A small pressure spring 95 for resetting is arranged between a lower side of the pressing plate 94 and the upper end surface of the frame 1.

In the embodiment, an upward extension part of the frame 1 on the opposite side of the grip is provided with a first accommodation hole la and a second accommodation hole 1b, and the ends, away from the pressing plate 94, of the speed decreasing plate 92 and the step-down plate 96 are respectively inserted into the first accommodation hole 1a and the second accommodation hole 1b.

In the embodiment, the stroke adjusting device 91 is a screw which is axially movably screwed to the upper end of the first accommodation hole la of the frame 1 in an axial direction, and a descending stroke is adjusted through an axial displacement change of the screw. The stroke adjusting device accurately adjusts the distance between the stroke adjusting device and the speed decreasing plate 92 inserted into the first accommodation hole 1a to change an up-down moving range when the height descending device is pressed, so as to achieve an adjustable step-down stroke. A self-positioning device 91a can be or is arranged in a middle of the screw to keep a stable position of the screw. A rotating part is arranged at an upper end of the screw, so that the rotating part is adjusted in a more convenient and labor-saving manner.

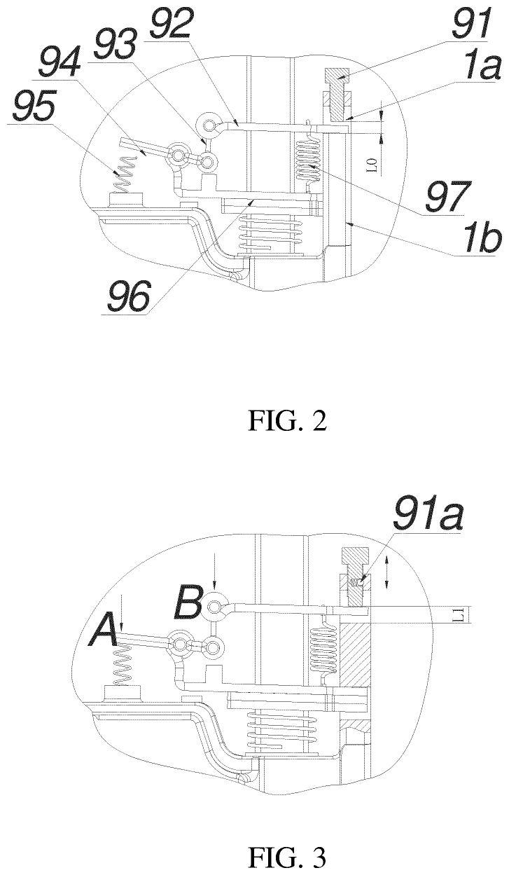

In the present invention, the specific step-down process of pressing a point A to step down is as follows: as shown in FIG. 2, in an initial state where the pressing plate 94 is not pressed, the step-down plate 96 is in an inclined state high in the left part and low in the right part under the action of the descending stopping spring 6 and forms a descending stopping inclination angle with the support rod 5, and in this case, the frame 1 may be kept immovably at any height of the support rod 5. As shown in FIG. 3 to FIG. 5, when the point A of the pressing plate 94 is pressed, the connecting plate 93 is pried to move upwards under the lever action of the step-down plate 96, so that the speed decreasing plate 92 moves upwards. However, as a right end of the speed decreasing plate is pulled by the elastic retainer 97, which is a tension spring, the speed decreasing plate 92 is also in the inclined state high in the left part and low in the right part and forms a self-locked lifting stopping inclination angle with the support rod 5 as well; and in this case, the point A is pressed downwards continuously, a pressing force will react on the step-down plate 96 through the connecting plate 93 by taking a hinge pin in the first pin hole 92c of the speed decreasing plate as a fulcrum, and the step-down plate 96 is pushed from the inclined state to a state where it is substantially perpendicular to the support rod 5, so that the step-down plate 96 and the support rod 5 are turned from the descending stopping locked state into a freely sliding state. In this case, a downward pressure is continuously applied to the point A to further push the support rod 5 to move upwards relative to the frame 1. Referring to the support rod 5, the frame 1 descends equivalently. The descending stroke is an idle stroke between the upper and lower ends of the first accommodation hole 1a. In this case, the downward pressing force at the point A is released, the step-down plate 96 is rapidly recovered to the inclined state which is high in the left part and low in the right part and stops descending with the support rod 5 under the action of the descending stopping spring 6, and the speed decreasing plate 92 also returns to the lower end from the upper end of the first accommodation hole 1a under the tensioning action of the elastic retainer 97, which is a tension spring and is kept in a freely sliding state where the speed decreasing plate is substantially perpendicular to the support rod 5. The pressing plate 94 and the connecting plate 93 are also recovered to the initial state, and the difference lies in that the displacement has changed once between the frame 1 and the support rod 5. By circularly pressing the point A and releasing the pressing force, the frame 1 may descend relative to the support rod 5 step by step, and the descending stroke in each step is stable. When it is necessary to increase the descending stroke, the adjusting device is displaced upwards, and in this case, the movable stroke range of the speed decreasing plate 92 increases from L0 to L1, so does the stroke generated by pressing the point A to step down; and on the contrary, the step-down stroke decreases.

In the embodiment, the descending stroke is adjusted by arranging the stroke adjusting device, so that the requirements of usage scenarios where the descending height is accurately controlled can be satisfied.

### Embodiment II

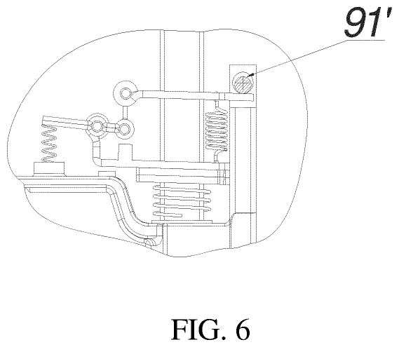

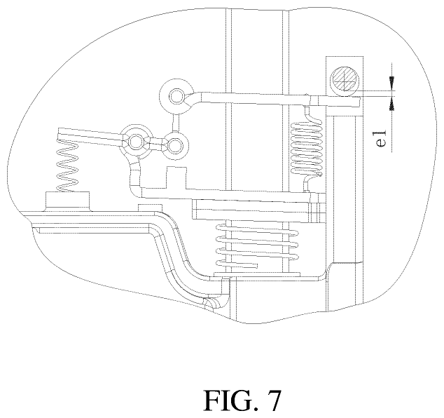

Referring to FIG. 6 and FIG. 7, the difference between the embodiment and the embodiment I lies in that the stroke adjusting device 91′ in the embodiment is an eccentric locking shaft rotatably mounted on a side wall of the first accommodation hole of the frame 1 along a radial direction, and the descending stroke is adjusted by a change of an eccentric amount of the eccentric locking shaft. The step-down stroke may increase or decrease by e1.

Remaining structures and functions all may refer to the description in the embodiment I.

1. A descending stroke adjustable device for a lifting tool, the lifting tool comprising:
a frame, a trigger, a support rod, a descending stopping spring, a lifting piece, and a lifting reset spring, the support rod being axially arranged in a penetrating manner in the frame;
a lower end of the support rod being located out of the frame and a support leg being arranged at the lower end of the support rod; a lifting leg being arranged at a lower end of the frame; and
a separation distance between the lifting leg and the support leg being adjusted by moving the support rod,
the support rod, being located inside the frame, being equipped with a lifting piece which is capable of driving said support rod to move downwards;
the lifting reset spring being arranged between the lifting piece and the frame;
the lifting piece being connected to a trigger driving the lifting piece to incline downwards; and
the trigger being hinged to the frame and forming an included angle with a grip on one side of an upper part of the frame, wherein the descending stroke adjustable device is mounted out of an upper end of the frame, the descending stroke adjustable device comprises a height descending device and a stroke adjusting device, the height descending device is penetrated by the support rod and a descending stopping spring is compressively mounted between the height descending device and an upper end surface of the frame,
wherein the height descending device and the support rod keep a descending stopping inclination angle; and
wherein the stroke adjusting device achieves an adjustable step-down stroke by controlling an up-down moving range when the height descending device is pressed.

2. The descending stroke adjustable device for a lifting tool according to claim 1, wherein the height descending device comprises a speed decreasing plate and a step-down device; the step-down device comprises a step-down plate and a pressing plate in pin connection; the speed decreasing plate and the step-down plate are arranged up and down; the speed decreasing plate and the step-down plate both are correspondingly provided with through holes for the support rod to penetrate through; ends, away from the pressing plate of the speed decreasing plate and the step-down plate are connected through an elastic retainer; and an end, close to the pressing plate, of the speed decreasing plate is hinged with one end of the pressing plate through a connecting plate.

3. The descending stroke adjustable device for a lifting tool according to claim 2, wherein the step-down plate is further provided with a joining part (96d) below a hinged position of the connecting plate and the pressing plate, and when a hinged part of the speed decreasing plate is pressed down, the connecting plate is linked and the joining part is pressed to drive the step-down plate to be kept perpendicular to the support rod synchronously.

4. The descending stroke adjustable device for a lifting tool according to claim 2, wherein the elastic retainer is a tension spring.

5. The descending stroke adjustable device for a lifting tool according to claim 2, wherein a small pressure spring for resetting is arranged between a lower side of the pressing plate and the upper end surface of the frame.

6. The descending stroke adjustable device for a lifting tool according to claim 2, wherein an upward extension part of the frame on the opposite side of the grip is provided with a first accommodation hole and a second accommodation hole, and the ends, away from the pressing plate, of the speed decreasing plate and the step-down plate are respectively inserted into the first accommodation hole and the second accommodation hole.

7. The descending stroke adjustable device for a lifting tool according to claim 6, wherein the stroke adjusting device is a screw which is axially movably screwed to the upper end of the first accommodation hole of the frame in an axial direction, and an up-down moving range of the speed decreasing plate is accurately controlled through an axial displacement change of the screw to adjust a descending stroke.

8. The descending stroke adjustable device for a lifting tool according to claim 7, wherein a self-positioning device for keeping a stable position of the screw is arranged in a middle of the screw.

9. The descending stroke adjustable device for a lifting tool according to claim 7, wherein a rotating part is arranged at an upper end of the screw.

10. The descending stroke adjustable device for a lifting tool according to claim 6, wherein the stroke adjusting device is an eccentric locking shaft rotatably mounted on a side wall of the first accommodation hole of the frame along a radial direction, and the up-down moving range of the speed decreasing plate is accurately controlled through a change of an eccentric amount of the eccentric locking shaft to adjust a descending stroke.
